(19) United States
(12) Patent Application Publication
(10) Pub. No.: US 2005/0077171 A1
(43) Pub. Date: Apr. 14, 2005

(54) Apparatus for treating elongated multi-layer webs of electrostatically chargeable material

(75) Inventors: Gunther Hagemann, Hamburg (DE); Thorsten Gadtke, Wedel (DE); Frank Herpell, Hamburg (DE)

Correspondence Address: VENABLE, BAETJER, HOWARD AND CIVILETTI, LLP, P.O. BOX 34385, WASHINGTON, DC, 20043-9998, US

(73) Assignee: E.C.H. Will GmbH, Hamburg (DE)

(21) Appl. No.: 10/946,617

(22) Filed: Sep. 22, 2004

(30) Foreign Application Priority Data
Sep. 22, 2003 (DE) 103 44 192.1-27

(51) Int. Cl. B42C 1/10

(52) U.S. Cl. 204/164

(57) ABSTRACT

The invention relates to apparatus for treating a multi-panel or multi-sheet web of paper or similar electrostatically chargeable material. A multi-layer web of such material is advanced toward and through at least one cutter to yield a succession of stacks which are ready for assembly into piles and/or for other processing. The arrangement for moving the web and there-upon the stacks lengthwise includes a first unit up-stream and a second unit downstream of the cutter, and an ionizing unit is installed adjacent the path of the web and stacks, either between the first moving unit and the cutter or between the cutter and the second moving unit. In either event, the ionizing unit is closely adjacent the cutter. If the stacks are to be assembled into a succession of piles downstream of the second moving unit, the apparatus further comprises an electrostatic discharging device in the region of the pile forming station.

### CROSS-REFERENCE TO RELATED CASES

This application claims the priority of the commonly owned German patent application Serial No. 103 44 192.1-27 filed Sep. 22, 2003.

The disclosure of the above referenced German patent application, as well as those of all other patents and/or patent applications identified in the specification of the present application, are incorporated herein by reference.

### BACKGROUND OF THE INVENTION

The invention relates to improvements in apparatus for treating or manipulating multi-layer webs of paper or other sheet material, and more particularly to improvements in methods of and in apparatus for processing superimposed sheets of electrostatically chargeable material. Still more particularly, the invention relates to improvements in methods of and in apparatus for treating multi-layer webs of electrostically chargeable sheet material (such as paper) in a plant wherein a multi-layer web is electrostatically charged to facilitate its treatment and is thereupon subdivided or severed to yield a succession of discrete stacks which can be assembled (superimposed) into piles ready to be packed and/or subjected to further and/or alternative treatments.

Presently known apparatus of the above outlined character further comprise means for advancing the web lengthwise along a predetermined path, and such advancing means comprise a first unit which is located upstream of the web subdividing or severing means and a second advancing unit which is disposed downstream of the web subdividing or severing means (as seen in the direction of lengthwise movement of the web).

A drawback of presently known apparatus of the just outlined character is that the transport of the continuous web which issues from the paper making machine and/or the transport of discrete stacks of superimposed paper sheets often presents serious problems, e.g., during transport from a preceding to a next-following processing station, such as to a stacking or piling-up station and/or to a packing station. For example, the sheets of a stack of superimposed sheets are likely to shift relative to each other due to acceleration and/or deceleration of certain (e.g., outer) sheets in a stack.

Other problems arise due to different modes of engagement between different sheets of a stack and the adjacent constituents of the stack advancing, accelerating, decelerating and/or diverting means. It has been found that the just outlined problems are particularly likely to arise during pronounced acceleration or deceleration of stacks of superimposed sheets as well as during abrupt changes of the direction of movement of a stack. Such treatment can result in more or less pronounced shifting of sheets in a stack relative to each other; this entails problems during further transport of the thus deformed or distorted stacks and/or during assembly of stacks into larger stacks or piles which should be ready for wrapping into paper or plastic sheet material, into cartons or other receptacles and the like. In many instances, even minor shifting of discrete sheets and/or smaller groups of neighboring sheets in a stack prevents or renders more difficult further processing of such commodities.

German patent No. 35 085 14 A1 proposes electrostatic charging of stacks of superimposed paper sheets or the like; this results in temporary prevention of shifting of neighboring sheets in an electrostatically charged stack relative to each other. It has been as-certained that such treatment reduces the likelihood of shifting of neighboring sheets relative to each other during acceleration of a stack in a manner such that certain sheets exhibit a more pronounced tendency to accelerate than the other sheet or sheets of the same stack. In addition, such treatment of stacks normally prevents individual sheets of a stack to fly off the remainder of the stack.

German patent No. 101 28 653 A1 proposes to employ an ionization device which cooperates with a sheet transporting unit to charge the sheets of stacks of superimposed sheets while the stacks are in motion. This publication further proposes to employ a suction generating device which operates in the region of a front transporting unit for successive stacks of sheets to act at least upon a portion of each successive advancing stack.

### OBJECTS OF THE INVENTION

An important object of the present invention is to further reduce the likelihood of misalignment of sheets in stacks and other accumulations of superimposed sheets.

Another object of this invention is to improve the cooperation of an electrostatic sheet charging arrangement with other component parts of machines for the making and processing of stacks of superimposed sheets or paper or the like.

A further object of the instant invention is to provide an optimal position for the electrostatic charging device or devices in apparatus wherein multi-layer webs of paper or the like are converted into stacks of superimposed sheets.

An additional object of our invention is to provide a novel and improved combination of stack forming and stack superimposing devices, particularly in an apparats of the above outlined character.

Still another object of the invention is to provide a paper making machine which cooperates with or embodies an apparatus of the above outlined character.

A further object of the invention is to provide a novel and improved method of preventing, or reducing the extent of, shifting of sheets in stacks of two or more superimposed sheets or panels which are obtained by repeatedly severing a running multi-layer web of paper or the like.

Another object of the present invention is to provide an apparatus of the above outlined character which can be readily combined with or installed in existing paper making, piling and subdividing machines.

### SUMMARY OF THE INVENTION

One feature of the present invention resides in the provision of an apparatus for treating a multi-layer web or an analogous accumulation of paper or other electrostatically chargeable material. The improved apparatus comprises means for advancing the web lengthwise in a predetermined direction along a predetermined path, and means for repeatedly severing the web including at least one subdividing arrangement (such as a pair of drums carrying cutting edges which extend beyond the peripheral surfaces of the respective drums) at a first portion of the path serving to ensure that the web yields a succession of discrete multi-layer stacks. The advancing means includes a first unit at a second portion of the path upstream of the first portion (as seen in the predetermined direction) and a second unit at a third portion of the path downstream of the first portion (again as seen in the predetermined direction), and the apparatus further comprises an electrostatic charging device for the web. In accordance with the invention, the electrostatic charging device is located in the region of one of the advancing units adjacent the severing means.

The electrostatic charging device can be located essentially between the at least one subdividing arrangement and one of the first and second units of the advancing means.

One of the first and second units of the advancing means can comprise at least one endless belt or band conveyor having an upper reach which is arranged to support from below that portion of the multi-layer web that is disposed in the path portion at the one unit of the advancing means. Such one unit of the advancing means can comprise a plurality of endless belt or band conveyors.

At least the second unit of the advancing means can comprise means for pneumatically attracting the web in the third portion of the path, and such second unit can comprise at least one endless band conveyor having an upper reach which is adjacent the respective portion of the path for the web; the attracting means of such apparatus is or can be adjacent to and is or can be disposed beneath the upper reach of the band conveyor. The attracting means can include a foraminous portion, and the aforementioned upper reach can overlie such foraminous portion. The at least one endless band conveyor can be a perforated conveyor.

The electrostatic charging device can include means for ionizing the web.

The at least one subdividing arrangement can comprise means for severing the web at least substantially transversely of the predetermined direction.

The improved apparatus can further comprise means for superimposing the stacks of the severed web to form a pile of stacks downstream of the advancing means (as seen in the predetermined direction), and means for dissipating the electrostatic charge of the web in the region of the superimposing means.

Another feature of the present invention resides in the provision of an apparatus for treating an elongated multi-layer web of paper or other electrostatically chargeable material. This apparatus comprises means for advancing the web lengthwise in a predetermined direction, an electrostatic charging device for the web, means for repeatedly severing the web so that the web yields a succession of stacks of superimposed layers, means for superimposing the stacks upon each other to form a series of piles of superimposed stacks, and means for dissipating the electrostatic charges of the stacks downstream of the advancing means, as seen in the predetermined direction, in the region of the superimposing means. The latter can constitute or include a stacker with a stepwise descendable stack-supporting platform.

The means for dissipating the electrostatic charges is or can be disposed between the severing means and the superimposing means, as seen in the predetermined direction, and the charging device can be arranged to supply to the web a charge of a first polarity; the charge dissipating means of such apparatus can comprise a source of compressed air, means for applying to compressed air an electrostatic charge of a second polarity opposite the first polarity, and means for directing the thus charged compressed air against the stacks. The means for directing charged compressed air against the stacks can include means for directing such air against the trailing edges of the stacks which are located in the range of the just mentioned air directing means. The directing means can include a plurality of nozzles.

The means for dissipating the electrostatic charges can comprise a housing having a section which is adjacent the superimposing means and can constitute an abutment for superimposed stacks of the respective piles, and the aforementioned directing means is or can be provided at the aforementioned section of the housing.

The aforementioned section of the housing can constitute an abutment for superimposed stacks of the respective piles. Such section can include a wall having air discharging apearures.

The aforementioned dissipating means can include means for deionizing the stacks. In accordance with a presently preferred embodiment of the superimposing means of the second embodiment of the improved apparatus can include an upper portion which is arranged to receive stacks from the advancing means and a lower portion, and such apparatus can further comprise means for evacuating air from the lower portion of the superimposing means.

The novel features which are considered as characteristic of the invention are set forth in particular in the appended claims. The improved apparatus itself, however, both as to its construction and the modes of assembling, installing and operating the same, together with numerous additional important and advantageous features and attributes thereof, will be best understood upon perusal of the following detailed description of certain presently preferred specific embodiments with reference to the accompanying drawing.

### BRIEF DESCRIPTION OF THE DRAWING

FIG. 1 is a fragmentary schematic elevational view of an apparatus which embodies one form of the present invention and wherein the electrostatic charging device is located ahead of the severing means for a running web of superimposed paper sheets or the like;

FIG. 2 is a similar fragmentary schematic elevational view of an apparatus wherein the electrostatic charging device is installed downstream of the severing means;

FIG. 3 is a fragmentary plan view of an apparatus which can embody the features of the apparatus of FIG. 1 or 2 and wherein the electrostatic charging device is omitted; and

FIG. 4 is an enlarged fragmentary schematic elevational view of an apparatus which embodies a discharging device and a novel and improved stack accumulating arrangement.

### DESCRIPTION OF PREFERRED EMBODIMENTS

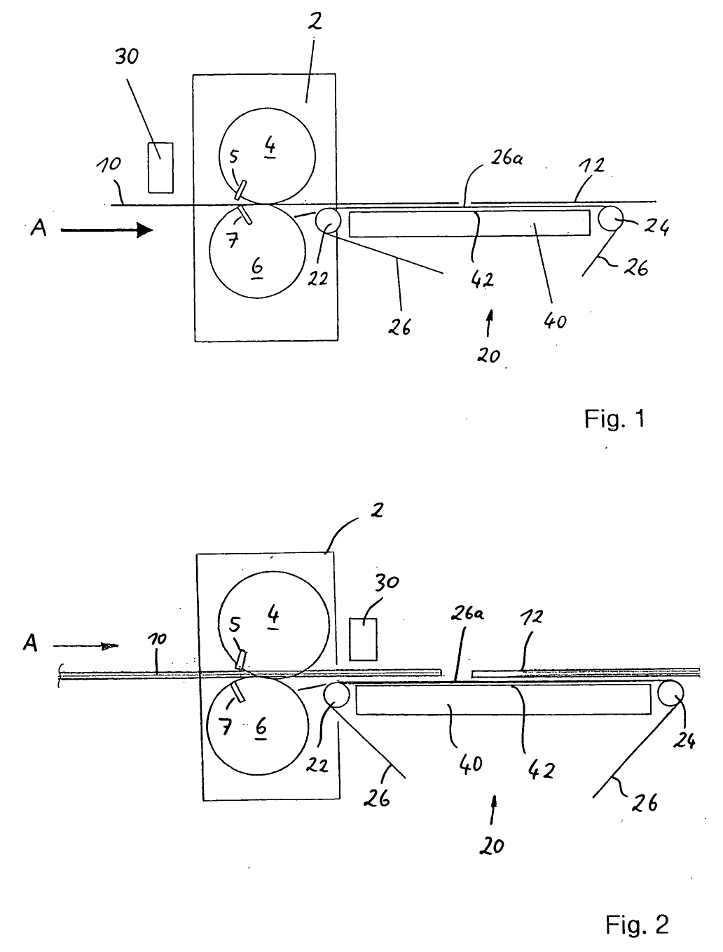

FIG. 1 shows in a side elevational view certain relevant parts of an apparatus which is installed in or combined with a paper making and/or processing machine and embodies one form of the present invention. The machine turns out a running multi-layer web or strip 10 of electrostatically chargeable paper, and the apparatus includes means (such as advancing units 20 of which only one can be seen in FIG. 1) for moving the web 10 lengthwise in a predetermined direction (indicated by an arrow A) toward, through and beyond a transverse cutter 2 constituting a device for repeatedly severing the web so that the latter yields a succession or series of preferably identical stacks 12 each containing two or more preferably accurately aligned overlapping paper sheets.

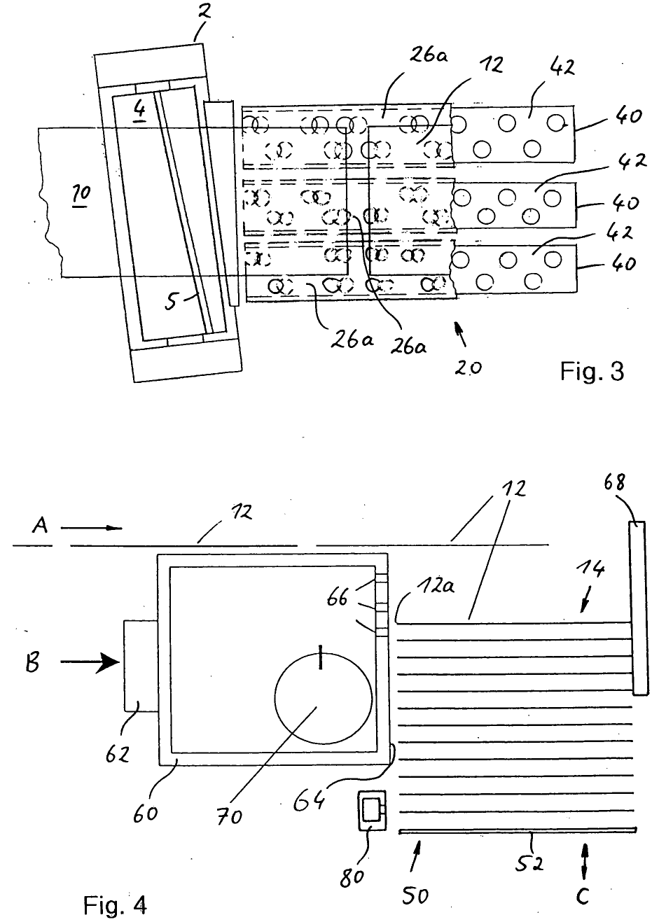

The illustrated cutter 2 comprises two preferably identical rotary drum-shaped carriers 4, 6 which are or which can be mirror images of each other with reference to a plane including the adjacent (first) portion of the path for the web 10 and stacks 12. The carriers 4, 6 respectively mount elongated knives 5, 7 which extend substantially lengthwise and along the full lengths thereof and can have elongated cutting edges oriented in a manner as shown in FIG. 3 so that they can subdivide the running web into a series of discrete stacks each having a square or a rectangular outline. The means (not shown in the drawing) for driving the drum-shaped carriers 4, 6 of the cutter 2 can include an electric motor and a suitable transmission.

The lengths of cutting edges of the knives 5, 7 can exceed the width of the web 10 and the widths of the discrete stacks 6 (see FIG. 3); these knives are omitted in FIG. 4 which shows a modified apparatus embodying a novel and improved stacking device 50 serving to superimpose selected numbers of successively formed stacks 12 to form piles 14 which are ready for draping or cartoning and/or other treatment not necessarily forming part of the present invention. FIG. 2 differs from FIG. 1 primarily or at least in that a suitable sheet ionizing unit 30 is located downstream (rather than upstream) of the cutter 2. In each of these embodiments, the ionizing device 30 is immediately or closely adjacent the cutter 2.

That unit (20) of the web and stack advancing means which is shown in FIGS. 1 to 3 comprises at least one endless belt but preferably a plurality (see FIG. 3) of endless belts or bands 26 which are trained over pulleys 22, 24 and have elongated upper reaches or stretches serving to support successive stacks 12 on their way toward the next processing station, e.g., to the stacking station (superimposing means) 50 of FIG. 4. The means for driving at least one of the pulleys 22, 24 can comprise an electric motor or a transmission (not shown) deriving motion from an electric motor or another suitable prime mover. The other unit of the advancing means supports and entrains the web 10 upstream of the cutter 2 and is (or can be) similar to or identical with the unit 10.

The ionizing unit 30 of FIG. 1 is arranged to electrostatically charge the sheets of the continuous web 10 adjacent (such as immediately adjacent) the cutter 2. This unit 30 can consist (and at the present time preferably consists) of or contain an ionizing rod or bar of known design; such bar can extend at right angles to the direction (arrow A) of forward movement of the web 10. The purpose of the unit 30 is to ensure that the neighboring sheets of the web 10 (and thereafter the neighboring sheets of successive stacks 12) adhere to each other with a force which suffices to ensure predictable, convenient, accurate and rapid processing of the sheets without risking any (or any appreciable) shifting of such neighboring sheets relative to each other.

The purpose of the ionizing unit 30 which is shown in FIG. 2 is to electrostatically charge the sheets of successive stacks 12 immediately downstream of the cutter 2. In fact, at least a portion of the unit 30 which is shown in FIG. 2 can actually overlie the second unit (20) of the composite sheet advancing means including a unit upstream and a unit downstream of the cutter 2.

The undersides of lowermost sheets of successively formed stacks 12 are attracted to the upper sides of upper reaches 26a of individual belts or bands of the composite endless belt or band conveyor 26 due to the provision of suction chambers 40 which are installed adjacent the undersides of the upper reaches 26a and are operatively connected to a pump (not shown) or another suitable suction generating device. The top wall 42 of each suction chamber 40 is foraminous (e.g., perforated as shown in FIG. 3), and the same holds true for the individual belts of the conveyor 26 (refer again to FIG. 3).

The suction chambers 40 enhance or complement the action of the electrostatic charging device 30 which latter opposes a peeling of upper sheets of successive stacks 12 from the sheets therebelow. The suction chambers 40 attract the stacks 12 to the upper reaches 26a of individual belts 26 of the respective conveyors. It has been determined that the just described unit 20 of the web advancing means reliably ensures predictable advancement of successive stacks 12 to and/or from the cutter 2, even if the web 10 and the stacks 12 are to be advanced at an elevated speed, e.g., in a modern mass-producing paper making and/or processing machine.

It will be appreciated that the heretofore described design of the improved apparatus can undergo numerous changes without departing from the spirit of the invention. For example, the distribution of perforations in the foraminous upper side 42 of each suction chamber 40 and/or in the individual endless belts of the belt conveyor 26 can depart from that which is shown in FIG. 3. Furthermore, a single belt conveyor 26 can be replaced by a series of two or more successive belt conveyors at least one of which can include two or more endless perforated (foraminous) belts. Still further, the suction chambers 40 can be movably (such as removably) mounted upstream and/or downstream of the cutter 2; for example, the suction chamber 40 which can be seen in FIG. 1 or 2 can be pivotably secured to the cutter 2 and/or to another part of the improved apparatus in order to facilitate inspection, cleaning and/or replacement. It is often advisable to install the suction chamber 40 in such a way that it is pivotable downwardly to a position in which its foraminous wall 42 is readily accessible. Still further, it is possible to employ one or more suction chambers 40 wherein the extent of suction is adjustable (or wherein the suction can be interrupted); this renders it possible to employ one and the same suction chamber 40 (or a set of such suction chambers) in conjunction with the transport of webs 10 and/or stacks 12 of different sizes and/or shapes, or in conjunction with webs and/or stacks which must be reliably transported at any one of two or more different speeds.

An important advantage of the heretofore described parts of the improved apparatus is that the second unit 20 of the web- and sheet-advancing means (i.e., the unit which is actually shown in FIGS. 1 to 3) can ensure reliable delivery of stacks 12 to a next processing station, e.g., to the accumulating or stacking station 50 of the type shown in FIG. 4 wherein selected numbers of stacks 12 are piled up on top of each other to assemble piles 14 (e.g., reams) which are ready for wrapping or cartoning or other modes of packing. In conventional apparatus, the stacks (corresponding to the stacks 12 shown in FIGS. 1 to 4) must be confined from below as well as from above (e.g., by resorting to (upper) endless band conveyor means at a level above the stacks issuing from the cutting or subdividing station). The possibility of dispensing with upper endless band conveyor means enhances the accessibility of the subdividing and/or stacking station(s) and simplifies the design and reduces the cost of the apparatus.

FIG. 4 shows schematically a portion of an apparatus wherein the means for repeatedly severing the web 10 (not shown) is omitted, together with the two units 20 of the means for advancing the web and the stacks. The second or downstream unit 20 is assumed to be located to the left of the structure which is shown in FIG. 4. Such structure includes the aforementioned stacking or superimposing station 50 which is designed to gather successive piles 14 each containing a predetermined number of superimposed stacks 12.

As a rule, or in many instances, an apparatus which forms and advances a continuous web 10 of discrete superimposed paper layers draws the layers from discrete rolls and causes the layers to overlie each other, i.e., to form the web 10. This web is processed, e.g., in a manner as already described with reference to FIGS. 1 to 3, to form a succession of discrete stacks 12 having predetermined sizes and shapes. Such mode of operation is desirable because it is not possible, or not always possible, to process selected lengths of a layer at the speed of the layer, i.e., it is necessary to decelerate the sheets which form a stack 12 to a speed at which the stacks can be properly processed (e.g., piled up in the arrangement 50 of FIG. 4 to form a series of successive piles 14 each containing a certain number of superimposed sheets).

Furthermore, it is often desirable to reduce (e.g., greatly reduce) the speed of the piles 14 in comparison with the speed at which the stacks 12 are being delivered to the station 50. Such reduction of speed is or can be desirable because the rate of processing of paper upstream of the station 50 can greatly exceed the rate of processing downstream of such station.

If the apparatus which includes the stacking or pile forming station 50 of FIG. 4 is not equipped with means (such as 30) for electrostatically charging the individual sheets of the web 10 and/or the stacks 12 (e.g., in a manner as already described with reference to FIGS. 1 to 3), the various movements of machine components nevertheless involve a certain electrostatic charging of sheets which form the stacks 12 and the piles 14. The extent of such charging is dependent upon the nature of the sheet material of which the panels of the stacks 12 and piles 14 are made and/or the circumstances of treatment or processing of such material.

Electrostatic charging of sheets which form the stacks 12 and piles 14 is desirable during certain stages of processing of the paper sheets or panels or webs (such as under the circumstances already described with reference to FIGS. 1 to 3, particularly during advancement by the second unit 20 downstream of the cutter 2). Such charging can interfere with proper assembly of piles 14 as well as (and often even more pronouncedly) with proper treatment of the piles 14 and/or of the contents of the piles. In other words, electrostatic charging is or can be desirable during one or more (earlier) stages of treatment of the web 10 and stacks 12, but can be less desirable or actually undesirable during one or more later stages which involve the treatment of piles 14 and/or their contents. In fact, electrostatic charging of the piles 14 and/or their contents can considerably reduce the productivity of the equipment which treats the piles 14 and/or the quality of the ultimate products.

In order to influence the electrostatic charges of the stacks 12 (and hence of the piles 14) downstream of the second advancing unit 20 (i.e., downstream of the cutter 2), the apparatus of FIG. 4 comprises a practically completely enclosed housing 60 having an inlet 62 which connects it to a source (not shown) of compressed air flowing in the direction of arrow B. That side of the housing 60 which confronts the stacking station 50 constitutes an upright wall 64 having outlets 66 which serve as air discharging nozzles or orifices or apertures to direct compressed air against the trailing marginal portions 12a of sheets forming the adjacent part of the pile 14 being gathered on the continuously or stepwise descending bottom wall or platform 52 of the stacking means at the station 50. The means (e.g., a reversible motor or the like) for moving the platform 52 up and down (see the double-headed arrow C) is not shown in FIG. 4.

The wall 64 further serves as a means for aligning the trailing edges 12a of the stacks 12 which form the pile 14 on the platform 52. The outlets 66 in the wall 64 confront an upright plate-like front aligning device 68 which cooperates with the wall 64 to assemble on the platform 52 a succession of piles 14 which descend with the platform and the lower parts of which can be evacuated from the stacking station 50 at a level below the aligning device 68 or in a direction toward or away from the observer of the structure shown in FIG. 4.

The apertures or nozzles 66 in the upper part of the stack aligning wall 64 of the housing 60 preferably extend along the full width of the wall 64 (as seen at right angles to the plane of FIG. 4), i.e., along the full lengths of the trailing edges 12a of stacks 12 forming the pile 14 on the platform 52. Such nozzles 66 are or can be uniformly distributed in the upper part of the wall 64. The arrangement is preferably such that the distribution and/or dimensions and/or the configurations of the nozzles 66 contribute to acceleration of streamlets of air which issue from the housing 60 and impinge upon the trailing edges 12a of the stacks 12 forming the pile 14 on the platform 52. The air streams issuing from the nozzles 66 ensure the establishment of air cushions between neighboring sheets of the pile 14 on the platform 52; such air cushions cooperate with means to be described herein-after in order to ensure the formation of piles 14 having predictable (optimum) shapes such as are best suited for further processing of the contents of successive piles. Movability of neighboring sheets at the stacking station 50 relative to each other is desirable if the walls 64, 68 are to ensure the assembly of piles 14 having accurately overlapping sheets. The establishment of air cushions between superimposed sheets on the platform 52 (such air cushions are established by the air streams issuing from the nozzles 66) is desirable on the additional ground that such sheets are more likely to descend toward the platform 52 in a highly predictable fashion.

In order to achieve a dissipation of electrostatic charges of the sheets forming part of the stacks 12 and piles 14 at the stacking station 50, the housing 60 contains an electrostatic discharging (deionizing) device 70, e.g., an antistatic rod or an equivalent thereof. The purpose of the device 70 is to ionize compressed air which is admitted into the housing 60 via inlet 70 with a polarity counter to that of the sheets in the stacks 12 at the station 50. In other words, the jets or streamlets of compressed air issuing from the housing 60 via nozzles 66 perform a deionizing action or effect upon the stacks 12 which form part of the growing pile 14 on the platform 52. Otherwise stated, the admission of compressed air having a deionizing effect upon the constituents of the growing piles 14 assists the aforementioned air cushions exactly at the locus where such effects are most desirable and (absolutely) necessary.

It is important to ensure, under all circumstances, that the housing 60 be disconnected from any current conducting parts. Furthermore, it is to be ensured that deionized compressed air issuing via nozzles 66 in the wall 64 of the housing 60 (as well as downstream of such nozzles) cannot come in contact with any current-conducting parts. Otherwise, the freshly deionized air which has been supplied into the housing 60 would undergo immediate neutralization.

The movements of the platform 52, especially its movement downwardly and away from the front aligning device 68, must be regulated in such a way that successive uppermost stacks 12 of the growing pile 14 at the station 50 are always located at a level between the uppermost and lowermost orifices 66 in the wall 64. This ensures the establishment of an optimal air cushion or optimal air cushions by the deionized fluid leaving the housing 60 at a level opposite the plate-like front aligning device 68.

FIG. 4 further shows a substantially strip-shaped suction-operated air evacuating device 80 which can share the movements of the platform 52 and serves to withdraw unnecessary air from the descending pile 14 on the platform 52. The device 80 evacuates by suction unnecessary air from the spaces between the super-imposed sheets of the pile 14, preferably from the lower portion of the latter.

An important advantage of the improved apparatus is that the ionizing unit 30 is closely or immediately adjacent the cutter 2, either upstream or downstream of the severing or subdividing station. This reliably prevents undesirable acccumulations of sheets and/or stacks 12 at the severing station which, in turn, greatly reduces the danger of damage to the relatively or highly expensive cutter.

It is presently preferred to install the electro-static ionizing unit or assembly 30 in a manner as shown in FIG. 2, namely downstream of and close to the cutter 2 and at the second (downstream) unit of the web- and stack-advancing means. The reason is that it is considered to be simpler to advance, via the downstream advancing unit of FIG. 2, a series of stacks 12 which were or are electrostatically charged subsequent to sub-division of the web 10 into a series of discrete stacks 12. Another advantage of the just discussed embodiment (with the ionizing unit 30 downstream of the cutter 2, as seen in the direction of arrow A) is that, at least under certain circumstances (such as with certain minor modifications), the upstream unit of the advancing means can be dispensed with.

The electrostatic ionizing unit 30 can at least partially overlap the upstream or the downstream unit (20) of the web- and stack-advancing means. The electrostatic charging operation can take place in close or immediate proximity (upstream or downstream) of the web severing station.

As already mentioned hereinbefore, the improved apparatus can constitute a simplification of conventional apparatus, for example, because the second unit of the web- and stack-advancing means need not employ an overhead component, e.g., an endless belt conveyor above the stacks 12 advancing with the upper reaches 26a of the endless belt or band conveyors 26 shown in FIGS. 1, 2 and 3. Such overhead conveyor(s) can be omitted because the electrostatically charged sheets of the stacks 12 suffice to prevent undesirable slipping, of such sheets in a stack relative to each other. The omission of one or more overhead conveyors contributes significantly to a simplification and reduction of cost of the apparatus.

Another important advantage of the improved apparatus is that there is no need for extensive adjustments such as, for example, conforming the positions of the conveyor belts or bands to the dimensions of the transported commodities and/or adjusting or selecting the friction of the lower endless belt or belts as a function of the friction of the upper belt or belts (as already mentioned hereinbefore, the upper belt conveyor(s) can be omitted). The unit or units (20) of the web and stack advancing means is or are readily accessible due to omission of the upper endless belt or belts; this, in turn, simplifies the repair work and access to various parts of the improved apparatus for reasons other than repair. Still further, the absence of overhead conveyor means reduces the likelihood of damage to the conveyed commodities (10 and/or 12); this is of particular importance if the conveyed commodities include lined or ruled paper which is much more susceptible to damage than plain paper.

The (second) sheet advancing unit 20 of FIGS. 1 to 3 can but need not operate with suction (see the suction chambers 40 and the foraminous belts 26). Operation with suction is desirable because it enhances the reliability and predictability of advancement of the stacks 12 and their sheets or panels.

The utilization of deionizing means in apparatus of the character to which the present invention pertains is already known in the art. Such deionizing devices are utilized to neutralize charges which develop as a result of contact of sheets or stacks of sheets with certain component parts of the sheet processing machines as well as due to relative movement between the component parts and the sheets. As already mentioned hereinbefore, such electrostatic charging of the sheets can adversely affect their processing. Presently known deionizing devices often include fixedly mounted antistatic units which are mounted at a level above and transversely of the entire path of sheets and are arranged to effect a discharge of the advancing material. The interval of influencing a normally rapidly advancing sheet or layer by a stationary overhead antistatic unit is very short so that such mode of operation cannot invariably ensure a complete electrostatic discharge. In addition, the sheets which advance beyond a stationary overhead deionizing device are likely to accumulate a fresh charge.

The electrostatic dissipating means 70 of FIG. 4 is arranged and is able to dissipate the charges which are gathered by the sheets of the stacks 12 advancing beyond the severing station because such dissipating means is installed at the stacking device 50. This will be readily appreciated since, owing to its very nature, a stacking or pile forming device necessarily maintains certain numbers or groups of sheets at a specific location for long or relatively long intervals or periods of time. This ensures complete (or at least highly adequate) discharge of the sheets with the result that the charge cannot interfere with subsequent processing of sheets forming the piles 14 as well as that the stacks are much more likely to accumulate into satisfactory piles.

The aforedescribed construction, installation and mode of operation of the charge dissipating means 70 also contribute to a more satisfactory operation of such means as well as to better utilization of arrangements which are adjacent thereto. As already explained hereinbefore, the charge dissipating means 70 is installed in or at a housing (60) which receives (at 62) a supply of compressed air and comprises or cooperates with a device for electrostatically charging compressed air in such a way that the polarity of this charge is opposite to that of sheets forming the stacks 12 at the pile forming station 50. The charge dissipating means 70 further cooperates with or comprises means (66) for blowing properly charged compressed air against the trailing edges 12a of sheets at the station 50.

The development of air cushions between the sheets which descend along the nozzles 66, in conjunction with appropriate charging of air streams issuing from the housing 60, and with the mechanical stacking means (such as 64, 68), ensures the formation of piles 14 having optimal sizes and shapes for further processing downstream of the station 50.

The making of air cushions between the sheets of stacks of paper sheets or the like is already known in the art. However, the present invention further provides for simultaneous utilization of cushion-forming air for at least one additional purpose, namely to effect or ensure a desirable or necessary electrostatic discharging of the sheets by the novel expedient of simply applying to compressed air issuing from the housing 60 at the nozzles 66 a polarity opposite that of the sheets forming the stacks 12 at a level above the platform 52. Controlled admission of compressed air via nozzles 66 ensures the establishment of an electrostatic discharging effect and proper action of compressed air upon the sheets of the stacks 12 at the locus or loci where the electrostatic discharge is absolutely necessary (namely at the locus of assembling stacks 12 into piles 14) and where it is desirable to ensure electrostatic neutralization of the sheets.

The feature that the housing 60 can perform several desirable and important functions contributes to simplicity and compactness of the improved apparatus. Thus, the housing 60 can receive compressed air (at 62), it can be provided with air accelerating means (nozzles 66) for highly predictable discharge of properly treated air, it can carry or otherwise cooperate with means (66) for deionizing compressed air, and it can carry or embody at least one (64) of the means (64, 68) for properly aligning the sheets and stacks 12 above the platform 52. The housing 66 can or should be made of an electrically non-conductive material.

Without further analysis, the foregoing will so fully reveal the gist of the present invention that others can, by applying current knowledge, readily adapt it for various applications without omitting features that, from the standpoint of prior art, fairly constitute essential characteristics of the generic and specific aspects of the above outlined contribution to the art of making and manipulating stacks of superimposed paper sheets or the like and, therefore, such adaptations should and are intended to be comprehended within the meaning and range of equivalence of the appended claims.

1. Apparatus for treating a multi-layer web of electrostatically chargeable material, comprising:
means for advancing the web lengthwise in a predetermined direction along a predetermined path;
means for severing the web, including at least one subdividing arrangement at a first portion of said path, so that the web yields a succession of discrete stacks, said advancing means including a first unit at a second portion of said path upstream of said first portion, as seen in said direction, and a second unit at a third portion of said path downstream of said first portion, as seen in said direction; and
an electrostatic charging device for the web, said device being located in the region of one of said units adjacent said severing means.

2. The apparatus of claim 1, wherein said charging device is located essentially between said at least one subdividing arrangement and one of said first and second units.

3. The apparatus of claim 1, wherein one of said first and second units comprises at least one endless band conveyor having an upper reach arranged to support from below that portion of the multi-layer web which is disposed in the path portion at said one unit of said advancing means.

4. The apparatus of claim 3, wherein said one unit of said advancing means comprises a plurality of endless band conveyors.

5. The apparatus of claim 1, wherein at least said second unit of said advancing means comprises means for pneumatically attracting the web in said third portion of said path.

6. The apparatus of claim 5, wherein said second unit includes at least one endless band conveyor having an upper reach adjacent the respective portion of said path and said attracting means is adjacent to and is disposed beneath said upper reach.

7. The apparatus of claim 6, wherein said attracting means includes a foraminous portion and said upper reach overlies said foraminous portion.

8. The apparatus of claim 6, wherein said at least one endless band conveyor is perforated.

9. The apparatus of claim 1, wherein said electrostatic charging device includes means for ionizing the web.

10. The apparatus of claim 1, wherein said at least one subdividing arrangement comprises means for severing the web at least substantially transversely of said predetermined direction.

11. The apparatus of claim 1, further comprising means for superimposing the stacks of the severed web to form a pile of stacks downstream of said advancing means, as seen in said predetermined direction, and means for dissipating the electrostatic charge of the web in the region of said superimposing means.

12. Apparatus for treating an elongated multi-layer web of electrostatically charged material so that the web yields a succession of stacks of sheets, comprising:
means for advancing the stacks in a predetermined direction;
means for superimposing the stacks upon each other to form a series of piles of superimposed stacks; and
means for dissipating the electrostatic charges of the stacks downstream of said advancing means, as seen in said predetermined direction, in the region of said superimposing means.

13. The apparatus of claim 12, further including means for repeatedly severing the web so that the web yields the succession of stacks;
wherein said dissipating means is disposed between said severing means and said superimposing means, as seen in said direction.

14. The apparatus of claim 13, wherein the web is electrostatically charged with a charge of a first polarity and said charge dissipating means comprises a source of compressed air, means for applying to compressed air an electrostatic charge of a second polarity opposite said first polarity, and means for directing the thus charged compressed air against the stacks.

15. The apparatus of claim 14, wherein the sheets of said stacks have leading edges and trailing edges, as seen in said predetermined direction, said means for directing charged compressed air including means for directing such air against the trailing edges of the stacks.

16. The apparatus of claim 14, wherein said directing means includes a plurality of nozzles.

17. The apparatus of claim 15, wherein said means for dissipating the electrostatic charges comprises a housing having a section adjacent said superimposing means and constituting an abutment for superimposed stacks of the respective piles, said directing means being provided at said section of said housing.

18. The apparatus of claim 12, wherein said means for dissipating the electrostatic charges comprises a housing having a section adjacent said superimposing means and constituting an abutment for superimposed stacks of the respective piles.

19. The apparatus of claim 18, wherein said section includes a wall having air discharging apertures.

20. The apparatus of claim 12, wherein said dissipating means includes means for deionizing the stacks.

21. The apparatus of claim 12, wherein said superimposing means includes an upper portion arranged to receive stacks from said advancing means and a lower portion, and further comprising means for evacuating air from the lower portion of said superimposing means.

22. Apparatus for treating a multi-layer web of electrostatically chargeable material, comprising:
means for advancing the web lengthwise in a predetermined direction along a predetermined path;
means for repeatedly severing the web, including at least one subdividing arrangement at a first portion of said path, so that the web yields a succession of discrete stacks, said advancing means being disposed at a second portion of said path, one of said first and second portions being located upstream of the other of said first and second portions of said path, as seen in said direction; and
an electrostatic charging device for the material in said path, said device being adjacent said severing means.
